(19) United States
(12) Patent Application Publication
(10) Pub. No.: US 2020/0158971 A1
(43) Pub. Date: May 21, 2020

(54) LONG SPAN DROP CABLES

(71) Applicant: AFL Telecommunications LLC, Duncan, SC (US)

(72) Inventors: Brett Villiger, Simpsonville, SC (US); Rebecca Walker, Central, SC (US); Rajesh Kamath, Kent, WA (US); Joseph Cignarale, Greer, SC (US)

(21) Appl. No.: 16/195,167

(22) Filed: Nov. 19, 2018

(51) Int. Cl. G02B 6/44

(52) U.S. Cl. CPC G02B 6/4433

(57) ABSTRACT

Drop cables are provided. A drop cable may include a central optical fiber, a buffer tube surrounding and in contact with the central optical fiber, and a plurality of strength members. Each of the plurality of strength members may have a maximum outer diameter of greater than 2.5 millimeters. The drop cable may further include an outer jacket surrounding and in contact with the buffer tube and the plurality of strength members such that the buffer tube and the plurality of strength members are embedded in the outer jacket. The outer jacket includes an outermost exterior surface of the drop cable and has a maximum outer diameter of less than or equal to 12 millimeters.

### FIELD

The present disclosure relates generally to drop cables, and more particularly to drop cables for use in long span applications.

### BACKGROUND

Optical fiber is increasingly being used for a variety of applications, including broadband applications such as voice, video and data transmissions. As a result of this increasing demand, fiber optic networks typically include a large number of mid-span access locations at which one or more optical fibers are branched from a distribution cable. These mid-span access locations provide a branch point from the distribution cable and may lead to an end user, commonly referred to as a subscriber. Fiber optic networks which provide such access are commonly referred to as FTTX “fiber to the X” networks, with X indicating a delivery point such as a premises (i.e. FTTP).

Various cable types and sizes are utilized throughout the network. For example, drop cables are utilized to connect the end user to the distribution cable. Typically, drop cables are utilized over relatively short distances, such as less than or equal to 150 feet. However, more recently, demand has increased for drop cables which can span longer distances, such as greater than 150 feet and in some cases greater than 350 feet, while still meeting certain design requirements, such as drop cables remain at a relatively low cost and have a relatively small diameter.

Accordingly, improved drop cable designs are desired in the art. In particular, improved drop cable designs which facilitate use over relatively long spans while meeting other design requirements would be advantageous.

### BRIEF DESCRIPTION

Aspects and advantages of the invention will be set forth in part in the following description, or may be obvious from the description, or may be learned through practice of the invention.

In accordance with some embodiments, a drop cable is provided. The drop cable includes a central optical fiber, a buffer tube surrounding and in contact with the central optical fiber, and a plurality of strength members. Each of the plurality of strength members has a maximum outer diameter of greater than 2.5 millimeters. The drop cable further includes an outer jacket surrounding and in contact with the buffer tube and the plurality of strength members such that the buffer tube and the plurality of strength members are embedded in the outer jacket. The outer jacket includes an outermost exterior surface of the drop cable and has a maximum outer diameter of less than or equal to 12 millimeters.

In some embodiments, the outer jacket is formed from a polyolefin. In some embodiments, the outer jacket is formed from a polyethylene. In some embodiments, the outer jacket is formed from a medium density polyethylene. In some embodiments, the maximum outer diameter of the outer jacket is less than or equal to 10 millimeters. In some embodiments, a cross-sectional profile of the outer jacket is circular.

In some embodiments, each of the plurality of strength members is formed from a fiber-reinforced polymer. In some embodiments, each of the plurality of strength members has a maximum outer diameter of greater than 3 millimeters. In some embodiments, the plurality of strength members is two strength members, the two strength members spaced apart from each other by approximately 180 degrees about the buffer tube when viewed in a cross-sectional profile.

In some embodiments, the buffer tube is formed from a polyester. In some embodiments, the buffer tube is formed from a polybutylene terephthalate. In some embodiments, the buffer tube is formed from a polypropylene. In some embodiments, the buffer tube has a maximum outer diameter of between 1.4 millimeters and 1.8 millimeters. In some embodiments, the buffer tube has a maximum thickness of between 0.4 millimeters and 0.8 millimeters.

In accordance with some embodiments, a drop cable is provided. The drop cable includes a central optical fiber, a buffer tube surrounding and in contact with the central optical fiber, and two strength members. Each of the plurality of strength members has a maximum outer diameter of greater than 2.5 millimeters. The two strength members are spaced apart from each other by approximately 180 degrees about the buffer tube when viewed in a cross-sectional profile. The drop cable further includes an outer jacket surrounding and in contact with the buffer tube and the plurality of strength members such that the buffer tube and the plurality of strength members are embedded in the outer jacket. The outer jacket includes an outermost exterior surface of the drop cable and has a maximum outer diameter of less than or equal to 12 millimeters.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a cross-sectional profile view of a drop cable in accordance with embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction.

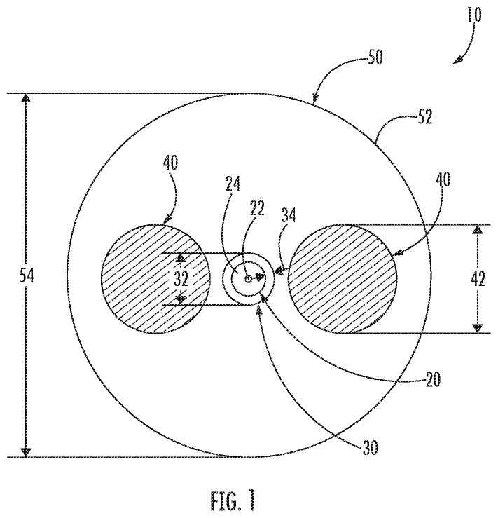

Referring now to FIG. 1, the present disclosure relates generally to improved drop cables 10. Drop cables 10 in accordance with the present disclosure can advantageously be utilized over relatively long spans, such as greater than 150 feet, greater than 250 feet, greater than 350 feet, and/or greater that or equal to 400 feet. In particular, such drop cables 10 can extend through such distances with less than one foot loaded sag, or less than 5% loaded sag, or less than 4% loaded sag, or less than 3% loaded sag. Loaded sag is calculated in accordance with NESC Heavy design criteria. Further, such drop cables 10 may advantageously have relatively small outer diameters and can advantageously be manufactured and deployed at relatively low costs.

Drop cables 10 in accordance with the present disclosure may further be capable of accommodating tensile loads of greater than 1200 pounds, such as greater than 1300 pounds, such as greater than 1400 pounds, such as greater than or equal to 1450 pounds.

Drop cables 10 in accordance with the present disclosure may further be capable of accommodating cable strain of greater than 0.6%, such as greater than 0.65%, such as greater than or equal to 0.67%.

As shown, a drop cable 10 in accordance with the present disclosure may include an optical fiber 20. The optical fiber may generally include a core 22 and one or more cladding and coating layers 24, as is generally understood. Any suitable optical fiber types may be utilized in accordance with the present disclosure, including for example single-mode or multi-mode optical fibers.

In exemplary embodiments, drop cable 10 includes only a single optical fiber 20, as shown. In exemplary embodiments, the optical fiber 20 is a central optical fiber, as shown.

Drop cable 10 may further include a buffer tube 30. The buffer tube 30 may surround and be in contact with the optical fiber 20. Buffer tube 30 may be formed from a suitable polymer material, such as a suitable thermoplastic. For example, buffer tube 30 may be formed from a polyester, such as in some embodiments, a polybutylene terephthalate. In some embodiments, the buffer tube 30 may be formed from a polypropylene.

Buffer tube 30 may have a maximum outer diameter 32 of between 1.4 millimeters and 1.8 millimeters, such as between 1.5 millimeters and 1.7 millimeters, such as approximately 1.6 millimeters. Buffer tube 30 may have a maximum thickness 34 of between 0.4 millimeters and 0.8 millimeters, such as between 0.5 millimeters and 0.7 millimeters, such as approximately 0.6 millimeters.

Drop cable 10 may further include one or more strength members 40, such as in some embodiments a plurality of strength members 40. In exemplary embodiments as shown, drop cable 10 includes two strength members 40. The strength member(s) 40 may, in exemplary embodiments, be formed from a fiber-reinforced polymer. For example, the fiber-reinforced polymer may be a glass-fiber reinforced polymer.

The strength member(s) 40 may be spaced from the buffer tube 30 and thus not in contact with the buffer tube 30. Additionally, when a plurality of strength members 40 are utilized, the strength members may be spaced from each other and thus not in contact with each other. The strength members 40 may, for example, be disposed in an annular array about the buffer tube 30 when viewed in a cross-sectional profile. In embodiments wherein only two strength members 40 are utilized, the two strength members 40 may be spaced apart from each other by approximately 180 degrees about the buffer tube 30 when viewed in a cross-sectional profile.

Each strength member 40 may have a maximum outer diameter 42 of greater than 2.4 millimeters, such as greater than 2.8 millimeters, such as greater than 3 millimeters, such as between 2.4 millimeters and 4 millimeters, such as between 2.8 millimeters and 3.7 millimeters, such as between 3 millimeters and 3.5 millimeters, such as between approximately 3.2 millimeters and approximately 3.3 millimeters.

In exemplary embodiments, each strength member 40 may have a modulus of elasticity of greater than 40 GPa, such as greater than 50 GPa.

Drop cable 10 further includes an outer jacket 50 which surrounds and contacts the buffer tube 30 and strength member(s) 40. Outer jacket 50 may have a solid cross-sectional profile, and the buffer tube 30 and strength member(s) 40 may be embedded in the outer jacket 50. Further, outer jacket 50 may include an outer surface 52 which is the outermost exterior surface of the drop cable 10. In exemplary embodiments, a cross-sectional profile of the outer jacket 50 may be circular.

Outer jacket 50 may be formed from a suitable polymer, such as suitable thermoplastic. For example, in some embodiments, outer jacket 50 may be formed from a polyolefin, such as in exemplary embodiments a polyethylene. The polyethylene may, for example, be a medium-density polyethylene (i.e. having a density range of between 0.926 g/cm3 and 0.940 g/cm3).

Outer jacket 50 may have a maximum outer diameter 54 of less than or equal to 12 millimeters, such as less than or equal to 11 millimeters, such as less than or equal to 10 millimeters, such as between 8 millimeters and 12 millimeters, such as between 9 millimeters and 11 millimeters, such as approximately 10 millimeters.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A drop cable, comprising:
a central optical fiber;
a buffer tube surrounding and in contact with the central optical fiber;
a plurality of uncoated strength members, each of the plurality of strength members having a maximum outer diameter of greater than 2.5 millimeters; and
an outer jacket surrounding and in direct contact with the buffer tube and the plurality of strength members such that the buffer tube and the plurality of strength members are embedded in the outer jacket, the outer jacket comprising an outermost exterior surface of the drop cable and having a maximum outer diameter of less than or equal to 12 millimeters.

2. The drop cable of claim 1, wherein the outer jacket is formed from a polyolefin.

3. The drop cable of claim 1, wherein the outer jacket is formed from a polyethylene.

4. The drop cable of claim 1, wherein the outer jacket is formed from a medium density polyethylene.

5. The drop cable of claim 1, wherein the maximum outer diameter of the outer jacket is less than or equal to 10 millimeters.

6. The drop cable of claim 1, wherein a cross-sectional profile of the outer jacket is circular.

7. The drop cable of claim 1, wherein each of the plurality of strength members is formed from a fiber-reinforced polymer.

8. The drop cable of claim 1, wherein each of the plurality of strength members has a maximum outer diameter of greater than 3 millimeters.

9. The drop cable of claim 1, wherein the plurality of strength members is two strength members, the two strength members spaced apart from each other by approximately 180 degrees about the buffer tube when viewed in a cross-sectional profile.

10. The drop cable of claim 1, wherein the buffer tube is formed from a polyester.

11. The drop cable of claim 1, wherein the buffer tube is formed from a polybutylene terephthalate.

12. The drop cable of claim 1, wherein the buffer tube is formed from a polypropylene.

13. The drop cable of claim 1, wherein the buffer tube has a maximum outer diameter of between 1.4 millimeters and 1.8 millimeters.

14. The drop cable of claim 1, wherein the buffer tube has a maximum thickness of between 0.4 millimeters and 0.8 millimeters.

15. A drop cable, comprising:
a central optical fiber;
a buffer tube surrounding and in contact with the central optical fiber;
two uncoated strength members, each of the plurality of strength members having a maximum outer diameter of greater than 2.5 millimeters, the two strength members spaced apart from each other by approximately 180 degrees about the buffer tube when viewed in a cross-sectional profile; and
an outer jacket surrounding and in direct contact with the buffer tube and the plurality of strength members such that the buffer tube and the plurality of strength members are embedded in the outer jacket, the outer jacket comprising an outermost exterior surface of the drop cable and having a maximum outer diameter of less than or equal to 12 millimeters.

16. The drop cable of claim 15, wherein the outer jacket is formed from a polyethylene.

17. The drop cable of claim 15, wherein the maximum outer diameter of the outer jacket is less than or equal to 10 millimeters.

18. The drop cable of claim 15, wherein a cross-sectional profile of the outer jacket is circular.

19. A drop cable, comprising:
a central optical fiber including a core and one or more of cladding and coating layers;
a buffer tube surrounding and in contact with an entire surface of an outer layer of the one or more cladding and coating layers of the central optical fiber;
a plurality of uncoated strength members each having a maximum outer diameter of greater than 2.5 millimeters, the plurality of strength members all arranged along a single elevation around the central optical fiber; and
an outer jacket in direct contact with entire outer surfaces of the buffer tube and all of the plurality of strength members, the outer jacket comprising an outermost exterior surface of the drop cable having a maximum outer diameter of less than or equal to 12 millimeters.
